(19) United States
(12) Patent Application Publication
(10) Pub. No.: US 2018/0185800 A1
(43) Pub. Date: Jul. 5, 2018

(54) MINERAL DISPERSION

(71) Applicant: Imerys Minerals Limited, Par, Cornwall (GB)

(72) Inventor: Desmond Charles PAYTON, St. Austell, Cornwall (GB)

(21) Appl. No.: 15/736,322

(22) PCT Filed: Nov. 7, 2016
(86) PCT No.: PCT/GB2016/053463

§ 371 Date: Dec. 14, 2017

(30) Foreign Application Priority Data
Nov. 17, 2015 (GB) 1520217.9

(51) Int. Cl. B01F 17/00; C09C 1/02

(52) U.S. Cl. CPC B01F 17/0007; C01P 2006/22; C09C 1/021; B01F 17/0028

(57) ABSTRACT

Use of an inorganic and an organic dispersant to disperse a particulate mineral in aqueous medium, for example wherein the inorganic dispersant is used to disperse the particulate mineral prior to a dewatering step and the organic dispersant is used to disperse the particulate mineral after the dewatering step, and products and intermediate products of said use.

### TECHNICAL FIELD

The present invention relates generally to the use of an inorganic dispersant and an organic dispersant to prepare a composition comprising particulate mineral, for example a dispersion of particulate mineral in aqueous medium. The present invention also relates to the products and intermediate products comprising particulate mineral and inorganic dispersant and/or organic dispersant. The present invention further relates to the various uses of these particulate mineral compositions and to products comprising these particulate mineral compositions.

### BACKGROUND

Particulate minerals are used in a wide variety of applications. For example, particulate minerals may be used as a filler or extender in numerous materials such as adhesives, sealants, glass, ceramics, films, rubber, paints, papers, inks and plastics. The particulate mineral may provide advantageous properties such as colour, opacity, gloss, rheology, hardness, chemical resistance, thermal resistance and thermal conductivity. The particulate mineral may also be used to reduce the amount of another component in a composition, for example, to reduce the toxicity and/or cost of the composition.

Particulate minerals are often stored, sold and transported as dry mineral or in aqueous suspensions (i.e. as a particulate mineral slurry). It is generally advantageous for compositions to have as high a solids content as possible to reduce the cost of transportation by reducing the amount of water that is transported. However, a higher solids content may cause a decrease in the stability of the aqueous suspension (e.g. cause settling at an earlier point in time such as during shipping or storage). Unstable or settled products might not be capable of being fully or easily re-dispersed or stabilized.

### SUMMARY

In a first aspect of the present invention, there is provided a use of an inorganic dispersant and an organic dispersant to disperse a particulate mineral in an aqueous medium.

In certain embodiments, the inorganic dispersant is used to disperse the particulate mineral in a first aqueous medium, the resultant dispersion is then dewatered and the organic dispersant is then used to disperse the particulate mineral in a second aqueous medium. In certain embodiments, the inorganic dispersant is used in an effective amount. Thus, in a further aspect of the present invention there is provided a use of an inorganic dispersant and an organic dispersant to disperse a particulate mineral in aqueous medium, wherein the inorganic dispersant is used to disperse the particulate mineral in a first aqueous medium prior to a dewatering step and the organic dispersant is used to disperse the particulate mineral in a second aqueous medium after the dewatering step, wherein the inorganic dispersant is used in an effective amount.

In certain embodiments, the organic dispersant is used to disperse a mineral composition comprising a particulate mineral and an inorganic dispersant in an aqueous medium. In certain embodiments, the mineral composition comprises an effective amount of an inorganic dispersant. In certain embodiments, the mineral composition has a solids content equal to or greater than about 50 wt %. Thus, in a further aspect of the present invention there is provided a method of dispersing a mineral composition, the method comprising combining the mineral composition and an aqueous medium in the presence of an organic dispersant, wherein the mineral composition comprises a particulate mineral and an effective amount of an inorganic dispersant, and has a solids content equal to or greater than about 50 wt %.

In one aspect of the present invention there is provided a particulate mineral composition made by a method of any aspect or embodiment of the present invention.

Thus, in a further aspect of the present invention there is provided a mineral composition comprising a particulate mineral, an inorganic dispersant and an organic dispersant.

In one aspect of the present invention there is provided a particulate mineral composition made as an intermediate of a method of any aspect or embodiment of the present invention.

Thus, in a further aspect of the present invention there is provided a mineral composition comprising a particulate mineral and an inorganic dispersant, wherein the mineral composition comprises an effective amount of the inorganic dispersant, has a solids content equal to or greater than about 50 wt % and is devoid of organic dispersant. In a further aspect of the present invention there is provided a method of making this mineral composition. Thus, in a further aspect of the present invention there is provided a method of dispersing a particulate mineral in aqueous medium, the method comprising combining the particulate mineral with the aqueous medium in the presence of an effective amount of an inorganic dispersant to form a mineral composition having a solids content equal to or greater than about 50 wt %, wherein the mineral composition is devoid of organic dispersant.

In certain embodiments of any aspect of the present invention the inorganic dispersant is combined with the particulate mineral and/or aqueous medium (e.g. first aqueous medium) prior to or during grinding of the particulate mineral in a first aqueous medium. In certain embodiments of any aspect of the present invention the organic dispersant is used to re-disperse the particulate mineral in an aqueous medium. In certain embodiments of any aspect of the present invention the organic dispersant is used to disperse the particulate mineral in aqueous medium (e.g. the second aqueous medium) after transportation of the composition comprising the particulate mineral and the inorganic dispersant.

In certain embodiments of any aspect of the present invention, the inorganic dispersant is used/present in an amount equal to or greater than about 0.2% by weight of the particulate mineral. In certain embodiments, the inorganic dispersant is used/present in an amount equal to or greater than about 0.3% by weight of the particulate mineral. In certain embodiments, the inorganic dispersant is used/present in an amount ranging from equal to or greater than about 0.2 to about 2% by weight of the particulate mineral. In certain embodiments, the inorganic dispersant is used/present in an amount ranging from equal to or greater than about 0.3 to about 2% by weight of the particulate mineral. In certain embodiments, the inorganic dispersant is used/present in an amount ranging from equal to or greater than about 0.4% to about 1.5% by weight of the particulate mineral.

In certain embodiments of any aspect of the present invention the inorganic dispersant is a phosphate salt. In certain embodiments, the inorganic dispersant is a condensed phosphate salt. In certain embodiments, the inorganic dispersant is a hexametaphosphate salt. In certain embodiments, the inorganic dispersant is a sodium salt.

In certain embodiments of any aspect of the present invention the organic dispersant comprises or is a homopolymer or copolymer of acrylic acid and/or methacrylic acid, for example a salt of a homopolymer or copolymer of acrylic acid and/or methacrylic acid. In certain embodiments, the organic dispersant is a polyacrylate salt. In certain embodiments, the organic dispersant is a sodium salt. In certain embodiments of any aspect of the present invention the organic dispersant comprises or is an alkanolamine. In certain embodiments, the organic dispersant comprises or is 2-amino-2-methyl-1-propanol.

In certain embodiments of any aspect of the present invention the organic dispersant is used/present in an amount ranging from about 0.2 to about 2% by weight of the particulate mineral.

In certain embodiments of any aspect of the present invention the particulate mineral is calcium carbonate. In certain embodiments, the particulate mineral is precipitated calcium carbonate (PCC). In certain embodiments, the particulate mineral is ground calcium carbonate (GCC).

In certain embodiments of any aspect of the present invention the particulate mineral is dispersed in a first aqueous medium at a solids content ranging from about 20 wt % to about 90 wt %. In certain embodiments, the particulate mineral is ground in a first aqueous medium at a solids content ranging from about 20 wt to about 90 wt %.

In certain embodiments of any aspect of the present invention, a mineral composition comprising the particulate mineral and the inorganic dispersant prior to addition of the organic dispersant has a solids content equal to or greater than about 50 wt % or equal to or greater than about 60 wt % or equal to or greater than about 70 wt %. In certain embodiments, a mineral composition comprising the particulate mineral and the inorganic dispersant prior to addition of the organic dispersant has a solids content ranging from equal to or greater than about 50 wt % to 100 wt % or from equal to or greater than about 60 wt % to 100 wt % or from equal to or greater than about 70 wt % to 100 wt % or from equal to or greater than about 70 wt % to about 90 wt % or from equal to or greater than about 70 wt % to about 80 wt %. In certain embodiments, a dispersion of the particulate mineral in the first aqueous medium is dewatered to form a mineral composition having a solids content greater than the solids content of the composition prior to dewatering, for example to form a mineral composition having a solids content equal to or greater than about 50 wt %. In certain embodiments, the dispersion is dewatered to form a composition having a solids content equal to or greater than about 60 wt % or equal to or greater than about 70 wt %. In certain embodiments, the dispersion is dewatered to form a composition having a solids content ranging from equal to or greater than about 50 wt % to 100 wt % or equal to or greater than about 60 wt % to 100 wt % or equal to or greater than about 70 wt % to about 100 wt %, for example from equal to or greater than about 70 wt % to about 90 wt %, for example from equal to or greater than about 70 wt % to about 80 wt %. In certain embodiments, the mineral composition may have a solids content ranging from about 30 wt % to about 70 wt % or from about 40 wt % to about 60 wt % prior to dewatering.

In certain embodiments of any aspect of the present invention, the composition comprising particulate mineral, inorganic dispersant and organic dispersant (e.g. the composition that is dispersed in a second aqueous medium after the dewatering step) has a solids content ranging from about 20 wt % to about 90 wt %. In certain embodiments, the composition has a solids content ranging from about 60 wt % to about 90 wt %.

In certain embodiments of any aspect of the present invention, the dispersion of the particulate mineral in the first aqueous medium has a Brookfield viscosity equal to or less than about 1500 mPa.s immediately after preparation. In certain embodiments, the dispersion of the particulate mineral in the first aqueous medium has a Brookfield viscosity equal to or less than about 600 mPa.s immediately after preparation. In certain embodiments, the dispersion of the particulate mineral in the first aqueous medium has a Brookfield viscosity equal to or greater than about 600 mPa.s one hour after preparation. In certain embodiments, the dispersion of the particulate mineral in the first aqueous medium has a Brookfield viscosity equal to or greater than about 1500 mPa.s one hour after preparation.

In certain embodiments of any aspect of the present invention, the dispersion of the particulate mineral in the second aqueous medium has a Brookfield viscosity equal to or less than about 1500 mPa.s immediately after preparation. In certain embodiments, the dispersion of the particulate mineral in the second aqueous medium has a Brookfield viscosity equal to or less than about 600 mPa.s immediately after preparation. In certain embodiments, the dispersion of the particulate mineral in the second aqueous medium has a Brookfield viscosity equal to or less than about 1500 mPa.s one hour after preparation. In certain embodiments, the dispersion of the particulate mineral in the second aqueous medium has a Brookfield viscosity equal to or less than about 600 mPa.s one hour after preparation.

In certain embodiments of any aspect of the present invention, the particle size distribution of the dispersion of the particulate mineral in the second aqueous medium is substantially the same as the particle size distribution of the particulate mineral prior to the dewatering step.

In certain embodiments of any aspect of the present invention, the dispersion of particulate mineral in the first aqueous medium is devoid of organic dispersant.

In certain embodiments of any aspect of the present invention, the dispersion of particulate mineral in the first aqueous medium and/or the dispersion of the particulate mineral in the second aqueous medium is devoid of calcium ion- and/or carbonate ion-containing compounds other than the particulate mineral itself. The details, examples and preferences provided in relation to any particular one or more of the stated aspect of the present invention apply equally to all aspects of the present invention. Any combination of embodiments, examples and preferences described herein in all possible variations thereof is encompassed by the present invention unless otherwise indicated herein, or otherwise clearly contradicted by context.

### DETAILED DESCRIPTION

### Use to Disperse a Particulate Mineral

There is provided herein the use of an inorganic dispersant and an organic dispersant to disperse a particulate mineral in aqueous medium. The embodiments described herein and all combinations thereof are equally applicable to all aspects of the present invention.

These uses may, for example, comprise combining particulate mineral and inorganic dispersant. The uses may, for example, further comprise combining organic dispersant with the mineral composition comprising particulate mineral and inorganic dispersant. The uses may, for example, comprise combining aqueous medium with any of these mineral compositions.

The inorganic dispersant may, for example, be used to disperse the particulate mineral in aqueous medium (e.g. a first aqueous medium) prior to a dewatering step.

The inorganic dispersant may, for example, be used to disperse the particulate mineral in aqueous medium (e.g. a first aqueous medium) prior to and/or during grinding of the particulate mineral in the aqueous medium. Alternatively or additionally, the inorganic dispersant may be used to disperse the particulate mineral in aqueous medium (e.g. a first aqueous medium) after grinding of the particulate mineral, for example grinding of the particulate mineral in the aqueous medium.

The organic dispersant may, for example, be used to disperse the particulate mineral in aqueous medium prior to and/or during grinding of the particulate mineral in the aqueous medium (e.g. together with the inorganic dispersant). Alternatively or additionally, the organic dispersant may be used to disperse the particulate mineral in aqueous medium (e.g. a first aqueous medium) after grinding of the particulate mineral, for example after grinding of the particulate mineral in the aqueous medium.

The mineral composition comprising the particulate mineral and the inorganic dispersant may, for example, be dewatered and/or ground and/or milled prior to the addition of the organic dispersant. The inorganic dispersant and/or the organic dispersant may, for example, be used to disperse the particulate mineral in aqueous medium (e.g. a second aqueous medium) after a dewatering step. The organic dispersant may be used to disperse the particulate mineral after the inorganic dispersant has been used to disperse the particulate mineral. The organic dispersant may, for example, be used to re-disperse the particulate mineral in aqueous medium. The organic dispersant may, for example, be used to disperse the particulate mineral on its own or in combination with any other particulate mineral, such as those described herein.

The first and second aqueous mediums may be the same or different. The first and/or second aqueous medium may, for example, be water. In certain embodiments, the first and second aqueous mediums are the same. For example, both the first and second aqueous mediums may be water.

For example, the inorganic dispersant may be used to disperse the particulate mineral in aqueous medium prior to a dewatering step (for example prior to or during grinding of the particulate mineral) and the organic dispersant is used to disperse the particulate mineral in aqueous medium after that dewatering step. The organic dispersant may, for example, be used to re-disperse the particulate mineral in aqueous medium.

The inorganic and organic dispersants may be combined with the particulate mineral in any manner known to those skilled in the art. For example, the inorganic and/or organic dispersant(s) may be used to disperse the particulate mineral by mixing the particulate mineral (and dispersant) in aqueous medium. For example, the inorganic and/or organic dispersant(s) may be used to disperse the particulate mineral during milling (to de-agglomerate particles) and/or grinding (to reduce the size of particles) of the particulate mineral in the aqueous medium.

The addition of the inorganic dispersant and the organic dispersant may, for example, take place at the same location. For example, the inorganic dispersant may be combined with the particulate mineral and the resultant mineral composition may be dewatered and stored at a relatively high solids content before the organic dispersant is combined with the dewatered mineral composition. For example, the inorganic and organic dispersants may be combined with the particulate mineral and the resultant mineral composition may be dewatered and stored at a relatively high solids content before the mineral composition is transported. Alternatively, the addition of the inorganic dispersant and the organic dispersant may take place at separate locations. For example, the inorganic dispersant may be combined with the particulate mineral at the resultant mineral composition may be dewatered at one location and the organic dispersant may be combined with the dewatered mineral composition at a second location. This may, for example, enable the mineral composition to be transported at a relatively high solids contents. For example, the dewatered mineral composition may be sold and delivered to a customer and the customer may disperse the mineral composition using the organic dispersant.

The optional dewatering step may, for example, enable the dewatered mineral composition to be stored and/or transported at relatively high solids content. The optional dewatering step may, for example, be carried out by one or more of mechanical dewatering (e.g. using presses, centrifuges and/or filtration) or thermal dewatering.

The dewatered mineral composition may have a solids content greater than the solids content of the composition prior to dewatering. The dewatered mineral composition may have a solids content equal to or greater than about 50 wt %. For example, the dewatered mineral composition may have a solids content equal to or greater than about 60 wt % or equal to or greater than about 70 wt %. For example, the dewatered mineral composition may have a solids content from equal to or greater than about 50 wt % to 100 wt % or equal to or greater than about 50 wt % to about 90 wt % or equal to or greater than about 60 wt % to 100 wt % or equal to or greater than about 60 wt % to about 90 wt % or equal to or greater than about 70 wt % to about 100 wt % or equal to or greater than about 70 wt % to about 90 wt %. For example, the dewatered mineral composition may have a solids content equal to or greater than about 75 wt %, for example equal to or greater than about 80 wt %, for example equal to or greater than about 85 wt %, for example equal to or greater than about 90 wt %, for example equal to or greater than about 95 wt %. For example, the dewatered mineral composition may have a solids content ranging from equal to or greater than about 70 wt % to equal to or less than about 95 wt %, for example from equal to or greater than about 75 wt % to equal to or less than about 90 wt %, for example from equal to or greater than about 80 wt % to equal to or less than about 90 wt %.

The mineral composition that is formed before any optional dewatering step (e.g. before the organic dispersant is introduced) may, for example, have a solids content ranging from about 20 wt % to about 90 wt % or from about 20 wt % to about 80 wt %. For example, the mineral composition may have a solids content ranging from about 30 wt % to about 70 wt %, for example from about 35 wt % to about 70 wt %, for example from about 40 wt % to about 60 wt % prior to introducing the organic dispersant and prior to any optional dewatering step. For example, the mineral composition may have a solids content within any one of these ranges during and/or after grinding.

The mineral composition comprising both the inorganic and organic dispersant (e.g. that is formed after dispersion with both the inorganic and organic dispersant) may, for example, have a solids content ranging from about 20 wt % to about 90 wt %, for example from about 30 wt % to about 90 wt %, for example from about 40 wt % to about 90 wt %, for example from about 50 wt % to about 90 wt %, for example from about 60 wt % to about 90 wt %, for example from about 60 wt % to about 85 wt %, for example from about 60 wt % to about 80 wt %, for example from about 65 wt % to about 80 wt %, for example from about 70 wt % to about 80 wt %.

The mineral composition that is formed before the organic dispersant is introduced (e.g. after dispersion with the inorganic dispersant but prior to dispersion with the organic dispersant) and before any optional dewatering step may initially have an acceptable viscosity for processing (e.g. for grinding and/or for shipping and/or for use at a customer site), but which may increase gradually over time, for example after about 1 hour or about 2 hours or about 6 hours or about 12 hours or about 24 hours. For example, the mineral composition that is formed before the organic dispersant is introduced (e.g. after dispersion with the inorganic dispersant but prior to dispersion with the organic dispersant) and before any optional dewatering step may initially have a Brookfield viscosity equal to or less than about 1500 mPa.s, for example equal to or less than about 1000 mPa.s, but which may increase gradually over time, for example after about 1 hour or about 2 hours or about 6 hours or about 12 hours or about 24 hours. For example, the Brookfield viscosity may increase gradually over time to greater than about 1000 mPa.s, for example greater than about 1500 mPa.s.

The mineral composition that is formed before the organic dispersant is introduced and before any optional dewatering step may, for example, have a Brookfield viscosity equal to or less than about 1500 mPa.s immediately after preparation. For example, the mineral composition comprising both the inorganic and organic dispersant may have a Brookfield viscosity equal to or less than about 1400 mPa.s or equal to or less than about 1300 mPa.s or equal to or less than about 1200 mPa.s or equal to or less than about 1100 mPa.s or equal to or less than about 1000 mPa.s or equal to or less than about 900 mPa.s or equal to or less than about 800 mPa.s or equal to or less than about 700 mPa.s, immediately after preparation. For example, the mineral composition that is formed before the organic dispersant is introduced and before any optional dewatering step may, for example, have a Brookfield viscosity equal to or less than about 600 mPa.s immediately after preparation. For example, the mineral composition formed before the organic dispersant is introduced and before any optional dewatering step may have a Brookfield viscosity equal to or less than about 550 mPa.s, for example equal to or less than about 500 mPa.s, for example equal to or less than about 450 mPa.s, for example equal to or less than about 400 mPa.s immediately after preparation. For example, the mineral composition that is formed before the organic dispersant is introduced and before any optional dewatering step may have a Brookfield viscosity ranging from 0 mPa.s to about 600 mPa.s, for example from about 10 mPa.s to about 600 mPa.s, for example from about 50 mPa.s to about 600 mPa.s, for example from about 100 mPa.s to about 600 mPa.s.

The mineral composition that is formed before the organic dispersant is introduced (e.g. after dispersion with the inorganic dispersant but prior to dispersion with the organic dispersant) and before any optional dewatering step may, for example, have a Brookfield viscosity equal to or greater than about 1000 mPa.s at least one hour after preparation. For example, the mineral composition formed before the organic dispersant is introduced and before any optional dewatering step may have a Brookfield viscosity equal to or greater than about 1200 or 1250 mPa.s, for example equal to or greater than about 1300 mPa.s, for example equal to or greater than about 1350 mPa.s, for example equal to or greater than about 1400 mPa.s, for example equal to or greater than about 1500 mPa.s, for example equal to or greater than about 1600 mPa.s, for example equal to or greater than about 1700 mPa.s, at least one hour after preparation. For example, the mineral composition that is formed before the organic dispersant is introduced and before any optional dewatering step may have a Brookfield viscosity ranging from about 1000 mPa.s to about 2500 mPa.s, for example from about 1300 mPa.s to about 2200 mPa.s, for example from about 1400 mPa.s to about 2000 mPa.s at least one hour after preparation. The mineral composition may, for example, have a Brookfield viscosity within any of these ranges about 2 hours or about 3 hours or about 4 hours or about 5 hours or about 6 hours or about 7 hours or about 8 hours or about 12 hours or about 16 hours or about 20 hours or about 24 hours or about 36 hours or about 48 hours after preparation.

The combination of inorganic and organic dispersant may, for example, enable a mineral composition to have both a relatively high solids content and an acceptable viscosity for further processing. The mineral composition comprising both the inorganic and organic dispersant (e.g. that is formed after dispersion with both the inorganic and organic dispersant) may, for example, have an acceptable viscosity for processing that is stable over a number of hours or days or weeks. The mineral composition comprising both the inorganic and organic dispersant may have a solids content as described herein, for example equal to or greater than about 70 wt %.

The mineral composition comprising both the inorganic and organic dispersant may, for example, have a Brookfield viscosity equal to or less than about 1500 mPa.s immediately after preparation. For example, the mineral composition comprising both the inorganic and organic dispersant may have a Brookfield viscosity equal to or less than about 1400 mPa.s or equal to or less than about 1300 mPa.s or equal to or less than about 1200 mPa.s or equal to or less than about 1100 mPa.s or equal to or less than about 1000 mPa.s or equal to or less than about 900 mPa.s or equal to or less than about 800 mPa.s or equal to or less than about 700 mPa.s, immediately after preparation. For example, the mineral composition comprising both the inorganic and organic dispersant may have a Brookfield viscosity equal to or less than about 600 mPa.s immediately after preparation. For example, the mineral composition comprising both the inorganic and organic dispersant may have a Brookfield viscosity equal to or less than about 550 mPa.s, for example equal to or less than about 500 mPa.s, for example equal to or less than about 450 mPa.s, for example equal to or less than about 400 mPa.s, immediately after preparation. For example, the mineral composition comprising both the inorganic and organic dispersant may have a Brookfield viscosity ranging from 0 to about 1500 mPa.s or from 0 to about 1200 mPa.s or from 0 to about 1000 mPa.s, immediately after preparation. For example, the mineral composition comprising both the inorganic and organic dispersant may have a Brookfield viscosity ranging from 0 to about 600 mPa.s, for example from about 10 to about 600 mPa.s, for example from about 50 to about 550 mPa.s, for example from about 100 to about 500 mPa.s, immediately after preparation.

The mineral composition comprising both the inorganic and organic dispersant may, for example, have a Brookfield viscosity equal to or less than about 1500 mPa.s at least one hour after preparation. For example, the mineral composition comprising both the inorganic and organic dispersant may have a Brookfield viscosity equal to or less than about 1400 mPa.s or equal to or less than about 1300 mPa.s or equal to or less than about 1200 mPa.s or equal to or less than about 1100 mPa.s or equal to or less than about 1000 mPa.s or equal to or less than about 900 mPa.s or equal to or less than about 800 mPa.s or equal to or less than about 700 mPa.s, at least one hour after preparation. For example, the mineral composition comprising both the inorganic and organic dispersant may have a Brookfield viscosity equal to or less than about 600 mPa.s at least one hour after preparation. For example, the mineral composition comprising both the inorganic and organic dispersant may have a Brookfield viscosity equal to or less than about 500 mPa.s, for example equal to or less than about 500 mPa.s, for example equal to or less than about 450 mPa.s, for example equal to or less than about 400 mPa.s, at least one hour after preparation. For example, the mineral composition comprising both the inorganic and organic dispersant may have a Brookfield viscosity ranging from 0 to about 1500 mPa.s or from 0 to about 1200 mPa.s or from 0 to about 1000 mPa.s, at least one hour after preparation. For example, the mineral composition comprising both the inorganic and organic dispersant may have a Brookfield viscosity ranging from 0 to about 600 mPa.s, for example from about 10 to about 600 mPa.s, for example from about 50 to about 550 mPa.s, for example from about 100 to about 500 mPa.s, at least one hour after preparation. The mineral composition comprising both the inorganic and organic dispersant may have a Brookfield viscosity within any of these ranges for up to about 2 hours or up to about 3 hours or up to about 4 hours or up to about 5 hours or up to about 6 hours or up to about 7 hours or up to about 8 hours or up to about 12 hours or up to about 16 hours or up to about 20 hours or up to about 24 hours or up to about 36 hours or up to about 48 hours or up to about 3 days or up to about 4 days or up to about 5 days or up to about 6 days or up to about 7 days or up to about 8 days or up to about 9 days or up to about 10 days or up to about 11 days or up to about 12 days or up to about 13 days or up to about 14 days after preparation.

Unless otherwise stated, viscosity is measured using a Brookfield R.V. viscometer or other similar instrument including spindles. Approximately 200 ml of sample is measured into a container. The temperature of the sample is adjusted to 22° C. A clean, dry spindle is immersed into the sample at a central position within the container. The speed is set to 10 rpm and the viscometer is switched on. The speed is then increased to 100 rpm and the spindle is allowed to rotate for 60 seconds±2 seconds. The viscometer reading is then noted.

Any particulate mineral (inorganic particulate mineral) capable of being provided in an aqueous suspension may be used in embodiments of the present invention. Suitable particulate minerals may be selected from one or more of the following: alkaline earth metal carbonate (for example dolomite, i.e. CaMg(CO₃)₂), metal sulphate (for example gypsum), metal silicate, metal oxide (for example iron oxide, chromia, antimony trioxide or silica), metal hydroxide, wollastonite, bauxite, talc (for example, French chalk), mica, zinc oxide (for example, zinc white or Chinese white), titanium dioxide (for example, anatase or rutile), zinc sulphide, calcium carbonate (for example precipitated calcium carbonate (PCC), ground calcium carbonate (GCC), for example obtained from limestone, marble and/or chalk, or surface-modified calcium carbonate), barium sulphate (for example, barite, blanc fixe or process white), alumina hydrate (for example, alumina trihydrate, light alumina hydrate, lake white or transparent white), clay (for example kaolin, calcined kaolin, China clay or bentonite), zeolites and combinations thereof. The material may be selected from any one or more of the materials listed. The particulate mineral may comprise a blend of any combination of the listed materials. For example, the particulate mineral may be calcium carbonate. For example, the inorganic particulate mineral may be precipitated calcium carbonate. Hereinafter, embodiments of the present invention may tend to be discussed in terms of calcium carbonate. However, the invention should not be construed as being limited to such embodiments.

When the inorganic particulate mineral used in embodiments of the present invention is obtained from naturally occurring sources, it may be that some mineral impurities will inevitably contaminate the ground material. For example, naturally occurring calcium carbonate occurs in association with other minerals. In general, however, the inorganic particulate mineral used in embodiments of the present invention will contain less than 5% by weight, preferably less than 1% by weight of other mineral impurities.

Calcium carbonate is particularly suitable for use in connection with embodiments of the present invention. Examples of calcium carbonate include ground calcium carbonate (GCC), precipitated calcium carbonate (PCC), dolomite and surface-modified calcium carbonate.

The particulate calcium carbonate used in embodiments of the present invention may be obtained from a natural source by grinding or may be prepared synthetically by precipitation (PCC), or may be a combination of the two, i.e. a mixture of the naturally derived ground material and the synthetic precipitated material. The PCC may also be ground.

Ground calcium carbonate (GCC) is typically obtained by grinding a mineral source such as chalk, marble or limestone, which may be followed by a particle size classification step, in order to obtain a product having the desired degree of fineness. The particulate solid material may be ground autogenously, i.e. by attrition between the particles of the solid material themselves, or alternatively, in the presence of a particulate grinding medium comprising particles of a different material from the calcium carbonate to be ground.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

PCC may be used as the source of particulate calcium carbonate in embodiments of the present invention, and may be produced by any of the known methods available in the art. TAPPI Monograph Series No 30, “Paper Coating Pigments”, pages 34-35, the contents of which are incorporated herein by reference, describes the three main commercial processes for preparing precipitated calcium carbonate which is suitable for use in preparing products for use in the paper industry, but may also be used in connection with the embodiments of the present invention. In all three processes, limestone is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process, the milk of lime is contacted with soda ash to produce, by double decomposition, a precipitate of calcium carbonate and a solution of sodium hydroxide. The sodium hydroxide should be substantially completely separated from the calcium carbonate if this process is to be commercially attractive. In the third main commercial process, the milk of lime is first contacted with ammonium chloride to give a calcium chloride solution and ammonia gas. The calcium chloride solution is then contacted with soda ash to produce, by double decomposition, precipitated calcium carbonate and a solution of sodium chloride. Alternatively, PCC may be made by reacting gypsum (calcium sulphate) with ammonium carbonate or ammonium bicarbonate. Alternatively, PCC may be made by reacting calcium chloride with sodium carbonate or ammonium carbonate.

The process for making PCC results in very pure calcium carbonate crystals and water. The crystals can be produced in a variety of different shapes and sizes, depending on the specific reaction process that is used. The three main forms of PCC crystals are aragonite, rhombohedral and scalenohedral, all of which are suitable for use in embodiments of the present invention, including mixtures thereof.

Use of the inorganic and organic dispersants may, for example, prevent or reduce aggregation of particulate mineral particles. Thus, the mineral composition comprising both the inorganic and organic dispersant may, for example, have substantially the same particle size distribution as the mineral composition that is formed before the organic dispersant is incorporated and before any optional dewatering step. Substantially the same particle size distribution may, for example, mean that the wt % of particles smaller than a certain particle size does not differ by more than about 3 wt %. For example, if the mineral composition formed before the organic dispersant is incorporated and before any optional dewatering step has 70 wt % of particles smaller than 2 microns, the mineral composition comprising both the inorganic and organic dispersant may have from 67 to 73 wt % of particles smaller than 2 microns. For example, the wt % of particles smaller than a certain particle size may not differ by more than about 2 wt % or by more than about 1 wt %.

The particulate mineral (at any time—e.g. both before and after dispersion with the organic dispersant), may, for example, have a particle size distribution such that from about 40% to about 100% of particles are smaller than 2 microns. For example, from about 45% to about 100%, for example from about 50% to about 99%, for example from about 50% to about 98%, for example from about 50% to about 97%, for example from about 50% to about 95%, for example from about 55% to about 92%, for example from about 55% to about 90%, for example from about 60% to about 85% of particles may be smaller than 2 microns.

The particulate mineral (at any time—e.g. both before and after dispersion with the organic dispersant) may, for example, have a particle size distribution such that from about 10% to about 80% of particles are smaller than 1 micron. For example, from about 15% to about 75%, for example from about 20% to about 70%, for example from about 25% to about 65%, for example from about 30% to about 60% of particles may be smaller than 1 micron.

The particulate mineral (at any time—e.g. both before and after dispersion with the organic dispersant) may, for example, have a particle size distribution such that from about 1% to about 60% of particles are smaller than 0.5 microns. For example, from about 2% to about 55%, for example from about 5% to about 50%, for example from about 10% to about 45% of particles may be smaller than 0.5 microns.

Unless otherwise stated, particle size properties referred to herein for the inorganic particulate mineral are as measured in a well known manner by sedimentation of the particulate filler or material in a fully dispersed condition in an aqueous medium using a Sedigraph 5100 machine as supplied by Micromeritics Instruments Corporation, Norcross, Ga., USA (telephone: +17706623620; web-site: www.micromeritics.com), referred to herein as a “Micromeritics Sedigraph 5100 unit”. Such a machine provides measurements and a plot of the cumulative percentage by weight of particles having a size, referred to in the art as the ‘equivalent spherical diameter’ (e.s.d), less than given e.s.d values. The mean particle size d₅₀ is the value determined in this way of the particle e.s.d at which there are 50% by weight of the particles which have an equivalent spherical diameter less than that d₅₀ value. The d₉₈, d₉₀ and the d₁₀ are the values determined in this way of the particle e.s.d. at which there are 98%, 90% and 10% respectively by weight of the particles which have an equivalent spherical diameter less than that d₉₈, d₉₀ or d₁₀ value.

The inorganic dispersant may, for example, be a phosphate salt. For example, the inorganic dispersant may be a condensed phosphate salt (formed when two or more orthophosphate acid molecules are condensed into one molecule), water-soluble salts of polysilicic acids or combinations thereof. For example, the inorganic dispersant may be a salt of pyrophosphoric acid, polyphosphoric acids (e.g. tripolyphosphoric acid, tetrapolyphosphoric acid, pentaphosphoric acid, hexaphosphoric acid), polymetaphosphoric acids (e.g. trimetaphosphoric acid, tetrametaphosphoric acid, pentaphosphoric acid, hexametaphosphoric acid), phosphoric anhydride and combinations thereof. For example, the inorganic dispersant may be a hexametaphosphate salt. The inorganic dispersant may, for example, be an alkali metal salt. For example, the inorganic dispersant may be a sodium salt. Hereinafter, embodiments of the present invention may tend to be discussed in terms of sodium hexametaphosphate. However, the invention should not be construed as being limited to such embodiments.

The inorganic dispersant may be used/present in the mineral composition in an effective amount. This means that the dispersant is present in a finite amount that is sufficient to give rise to de-flocculation of the particulate mineral. This means that the flocculation characteristics of the suspension are different to those that would be found in the absence of any dispersant. The effective amount of dispersant may be determined by adding doses of dispersant to a particulate mineral and measuring the viscosity of the particulate mineral material by Brookfield to determine the minimum viscosity. Viscosity is measured using Brookfield spindle #3, at 100 rpm, 10 seconds after mixing. The slurry is at 22° C. The viscosity of the particulate mineral is determined for increasing doses of dispersant until the viscosity does not decrease any further. The smallest dose that gives the lowest viscosity is the optimum dose. For example, something similar to a parabolic curve should be obtained (with viscosity on y axis and dose on x axis), where the viscosity first slopes downwards because the optimum dose has not yet been added and then increases after the optimum dose, for example due to the salt from the excess dispersant. If a parabolic curve is not seen, the dosing curve should be extended (e.g. if the curve just increases, lower doses of dispersant should be tested). An “effective amount” of dispersant is the optimum dose +/−30% (e.g. if the optimum dose is 2 wt %, an “effective amount” of dispersant is from 1.4 wt % to 2.6 wt %).

The inorganic dispersant may, for example, be used/present in an amount ranging from equal to or greater than about 0.2% to about 2% by weight of the particulate mineral. For example, the inorganic dispersant may be used/present in an amount ranging from equal to or greater than about 0.25% to about 2%, for example equal to or greater than about 0.3% to about 2%, for example from equal to or greater than about 0.4% to about 2%, for example equal to or greater than about 0.5% to about 2%, by weight of the particulate mineral. For example, the inorganic dispersant may be used/present in an amount ranging from equal to or greater than about 0.25% to about 1.5%, for example equal to or greater than about 0.3% to about 1.5%, for example from equal to or greater than about 0.4% to about 1.5%, for example equal to or greater than about 0.5% to about 1.5%, by weight of the particulate mineral. For example, the inorganic dispersant may be used/present in an amount ranging from equal to or greater than about 0.25% to about 1%, for example equal to or greater than about 0.3% to about 1%, for example from equal to or greater than about 0.4% to about 1%, for example equal to or greater than about 0.5% to about 1%, by weight of the particulate mineral. Any one of these ranges may be considered to be an “effective amount” of the inorganic dispersant.

The organic dispersant may, for example, comprise or be a homopolymer or copolymer of acrylic acid and/or methacrylic acid. For example, the organic dispersant may be a salt of a homopolymer or copolymer of acrylic acid and/or methacrylic acid. For example, the organic dispersant may, for example, be a polyacrylate salt. The organic dispersant may be an alkali metal salt. For example, the organic dispersant may be a sodium salt. The organic dispersant may, for example, be an alkanolamine. For example, the organic dispersant may be methanolamine, ethanolamine, propanolamine, butanolamine, pentanolamine, hexanolamine, heptanolamine, octanolamine or combinations thereof. For example, the organic dispersant may be 2-amino-2-methyl-1-propanol (AMP). Hereinafter, embodiments of the present invention may tend to be discussed in terms of sodium polyacrylate or 2-amino-2-methyl-1-propanol. However, the invention should not be construed as being limited to such embodiments.

The organic dispersant may be used/present in the mineral composition in an effective amount. This means that the dispersant is present in an amount that is sufficient to give rise to de-flocculation of the particulate mineral. This means that the flocculation characteristics of the suspension are different to those that would be found in the absence of any dispersant. This may be determined by as described above in relation to the inorganic dispersant. The organic dispersant may, for example, be used/present in an amount ranging from equal to or greater than about 0.2% to about 2% by weight of the particulate mineral. For example, the organic dispersant may be used/present in an amount ranging from equal to or greater than about 0.25% to about 2%, for example equal to or greater than about 0.3% to about 2%, for example from equal to or greater than about 0.4% to about 2%, for example equal to or greater than about 0.5% to about 2%. For example, the organic dispersant may be used/present in an amount ranging from equal to or greater than about 0.25% to about 1.5%, for example equal to or greater than about 0.3% to about 1.5%, for example from equal to or greater than about 0.4% to about 1.5%, for example equal to or greater than about 0.5% to about 1.5%. For example, the organic dispersant may be used/present in an amount ranging from equal to or greater than about 0.25% to about 1%, for example equal to or greater than about 0.3% to about 1%, for example from equal to or greater than about 0.4% to about 1%, for example equal to or greater than about 0.5% to about 1%. Any one of these range may be considered to be an “effective amount” of the organic dispersant.

### Compositions

There is also provided herein the compositions and intermediate compositions made by the methods/uses described herein. These compositions may be in accordance with any of the embodiments described herein, including all combinations thereof.

For example, a mineral composition formed prior to incorporation of the organic dispersant and after a dewatering step may comprise the particulate mineral, the inorganic dispersant and aqueous medium. This mineral composition may, for example, have a solids content equal to or greater than about 50 wt % or equal to or greater than about 60 wt % or equal to or greater than about 70 wt %. In certain embodiments, the composition may be in dry mineral form and consist essentially of or consist of these components. In certain embodiments, the composition may be in dry mineral form and be 100 wt % solids. This mineral composition may, for example, be substantially devoid of organic dispersant. For example, this mineral composition may comprise equal to or less than about 0.2% of organic dispersant based on the weight of the particulate mineral. For example, this mineral composition may be devoid of organic dispersant. This mineral composition may, for example, comprise an effective amount of inorganic dispersant. For example, this mineral composition may comprise equal to or greater than about 0.2% or equal to or greater than about 0.3% of inorganic dispersant based on the total weight of particulate mineral.

For example, a mineral composition formed after incorporation of the inorganic dispersant and the organic dispersant may comprise the particulate mineral, the inorganic dispersant and the organic dispersant. In certain embodiments, the composition may be in dry mineral form and consist essentially of or consist of these components. In certain embodiments, the composition may be in dry mineral form and be 100 wt % solids. In certain embodiments, the composition may be an aqueous slurry and may further comprise an aqueous medium. This mineral composition may, for example, comprise an effective amount of inorganic dispersant. For example, this mineral composition may comprise equal to or greater than about 0.2% or equal to or greater than about 0.3% of inorganic dispersant based on the total weight of particulate mineral. This mineral composition may, for example, comprise an effective amount of organic dispersant. For example, this mineral composition may comprise equal to or greater than about 0.2% or equal to or greater than about 0.3% of organic dispersant based on the total weight of particulate mineral.

Any mineral composition made by the methods/uses described herein and/or made as an intermediate of any of the methods/uses described herein may be devoid of calcium ion-containing and/or carbonate ion-containing compounds other than the particulate mineral itself. For example, any mineral composition made by the methods/uses described herein and/or made as an intermediate of any of the methods/uses described herein may be devoid of calcium hydroxide, calcium chloride, sodium carbonate and any combination thereof. Thus, the exclusion of calcium ion-containing and/or carbonate ion-containing compounds does not exclude the particulate mineral calcium carbonate from being present in the composition.

The aqueous suspension may optionally further comprise other additives. For example, the aqueous suspension may further comprise one or more further optional additives which affect the pH of the aqueous suspension, one or more thickening agents and/or one or more anti-settling agents.

The mineral compositions comprising inorganic and organic dispersant may be used in any application known to those skilled in the art. For example, the mineral compositions may be used as fillers or extenders in numerous materials such as adhesives, sealants, glass, ceramics, films, rubber, paints, papers, inks and plastics.

### EXAMPLES

Compositions comprising ground calcium carbonate, sodium hexametaphosphate and water was made in a small lab pot grinder. These compositions were made with a media volume concentration of about 50% (typically between 50% and 60%), a solids content of greater than about 50 wt %, a dose of sodium hexametaphosphate of about 1.5 wt % (1% added initially and further 0.5% increments were added throughout) and a target particle size distribution such that about 90 wt % of particles were smaller than 2 microns. The compositions were oven dried at 80° C. to contain zero moisture.

The compositions were then milled to less than 53 microns and made down in a make down mixer with water and sodium polyacrylate. These compositions were made with a target solids of about 79% and a sodium polyacrylate dose of about 0.85%. The compositions were diluted to 78 wt % at the end of the make-down.

It was found that there was no change in particle size distribution of the mineral composition after drying and make down with sodium polyacrylate. The viscosity of the final mineral composition was about 380 mPa.s.

1-20. (canceled)

21. A method of dispersing a mineral composition, the method comprising combining the mineral composition and an aqueous medium in the presence of an organic dispersant, wherein the mineral composition comprises a particulate mineral and an effective amount of an inorganic dispersant.

22. The method of claim 21, wherein the mineral composition is re-dispersed in the aqueous medium.

23. The method of claim 21, wherein the inorganic dispersant is a phosphate salt such as a condensed phosphate salt.

24. The method of claim 21, wherein the inorganic dispersant is a hexametaphosphate salt.

25. The method of claim 21, wherein the organic dispersant is a homopolymer or copolymer of acrylic acid and/or methacrylic acid or wherein the organic dispersant is an alkanolamine.

26. The method of claim 21, wherein the organic dispersant is salt of polyacrylate.

27. The method of claim 21, wherein the inorganic dispersant and/or organic dispersant is a sodium salt.

28. The method of claim 21, wherein the particulate mineral comprises ground calcium carbonate (GCC), particulate calcium carbonate (PCC), or another inorganic particulate mineral.

29. The method of claim 21, wherein the method comprises dispersing (e.g. grinding) the particulate mineral in a first aqueous medium in the presence of an inorganic dispersant to form the mineral composition.

30. The method of claim 29, wherein the method comprises dewatering the mineral composition such that it has a solids content ranging from equal to or greater than about 70 wt % to about 100 wt %.

31. The method of claim 30, wherein the mineral composition has a solids content ranging from about 20 wt % to about 90 wt %.

32. The method of claim 21, wherein the mineral composition comprises the inorganic dispersant in an amount equal to or greater than about 0.2% by weight of the particulate mineral.

33. The method of claim 21, wherein the organic dispersant is used in an amount ranging from about 0.2% to about 2% by weight of the particulate mineral.

34. The method of claim 21, wherein the dispersed mineral composition has a solids content ranging from about 30 wt % to about 90 wt %.

35. The method of claim 29, wherein the dispersion of the particulate mineral in the first aqueous medium has a Brookfield viscosity equal to or less than about 1500 m Pa.s immediately after preparation.

36. The method of claim 29, wherein the dispersion of the particulate mineral in the first aqueous medium has a Brookfield viscosity equal to or greater than about 1500 mPa.s one hour after preparation.

37. The method of claim 21, wherein the dispersed mineral composition has a Brookfield viscosity equal to or less than about 1500 mPa.s immediately after preparation.

38. The method of claim 21, wherein the dispersed mineral composition has a Brookfield viscosity equal to or less than about 1500 mPa.s one hour after preparation.

39. The method of claim 21, wherein the particle size distribution of the mineral composition is substantially the same as the particle size distribution of the dispersed mineral composition.

40. The method of claim 21, wherein the mineral composition is devoid of organic dispersant.

41. The method of claim 21, wherein the mineral composition is devoid of calcium ion-containing and/or carbonate ion-containing compounds.

42-59. (canceled)
